(19) United States
(12) Patent Application Publication
(10) Pub. No.: US 2014/0324737 A1
(43) Pub. Date: Oct. 30, 2014

(54) Switching Input Power Sources for Mobile Telecom Sites According to Time-Varying Electricity Prices

(71) Applicant: TELEFONAKTIEBOLAGET L M ERICSSON (PUBL), Stockholm (SE)

(72) Inventor: Mario Palma Serrano, Sevilla (ES)

(73) Assignee: Telefonaktiebolaget L M Ericsson (PUBL), Stockholm (SE)

(21) Appl. No.: 13/870,623

(22) Filed: Apr. 25, 2013

(51) Int. Cl. G06Q 50/06; G06Q 10/00

(52) U.S. Cl. CPC G06Q 50/06; G06Q 10/00
USPC 705/412

(57) ABSTRACT

An input-power switcher for a telecom site includes a sourcing unit for configuring two or more alternative energy sources as available at the telecom site. The switcher includes a pricing unit for storing time-varying price references from one or more different suppliers for at least one of the two or more alternative energy sources. The switcher includes a processing unit for selecting one amongst the two or more alternative energy sources for powering the telecom site The selection is made on the basis of the alternative energy sources available at the telecom site and the time-varying price references in the pricing unit The processing unit is in communication with the sourcing unit and the pricing unit. The switcher includes an actuator unit for switching to the selected, alternative energy source for powering the telecom site. The actuator unit in communication with the processing unit. A method of using an input-power switcher for a telecom site.

### TECHNICAL FIELD

The present invention generally relates to alternative energy sources in Radio Base Stations. (As used herein, references to the “present invention” or “invention” relate to exemplary embodiments and not necessarily to every embodiment encompassed by the appended claims.) More specifically, the invention relates to switching between the alternative energy sources.

### BACKGROUND

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art

A Radio Base Station (RBS) is placed at what is called, a site. The site provides power and environmental protection to the base station. All site are different with respect to energy consumption, site equipment, infrastructure, location, accessibility, etc. but they all need power to operate and provide service. RBSs consume over 50% of the total power in a telecom network. Mobile operators world-wide expend huge amounts of money to pay their energy bills to electricity supplier companies, being this fact responsible for an important part of their OPEX. Meanwhile, the price of electricity trends to increase continuously. A solution to reduce significantly the energy bills paid by operators is described along this invention disclosure.

Operators are trying to reduce their energy costs by a whole set of heterogeneous methods, all of them searching to improve efficiencies in their networks. Different alternatives are being developed by a number of telecom vendors and other IT and energy-industry actors. When combining an appropriate network design, different energy performance optimization functionalities, modern hardware equipment specially designed for low power consumption and alternative energy sources, then it is possible to face step by step the different energy challenges that mobile operators confront,

The price of the electricity used to feed telecom sites can change very significantly during different periods of a day. At present, none of the available methodologies to reduce energy costs in mobile networks is taking advantage of this fact.

Regarding the types of electricity price references, basically one can find flat rates or time-varying pricing. When customers pay a flat rate, it means that independently of when they use it, they pay the same for a unit of electricity. Alternatively, when using time-varying pricing, the price per unit of electricity varies according to the time of the day or night at which the consumption occurs; so in other words, it is just as important how much energy one uses as when one uses this energy.

Frequently, the customers can choose between a flat rate and a time-varying price for their electricity, especially when contracted power it is not very high; in many other circumstances, time-varying pricing has been mandated by authorities. Both flat rates and time-varying prices are public and stable during weeks or month, being, updated periodically by electricity companies. One can check different time-varying pricing tariff, where price differences between periods are even higher than 95%.

### BRIEF SUMMARY OF THE INVENTION

To overcome the problems mentioned above, or at least to mitigate them, the present invention provides for an input-power switcher for telecom sites. This input-power switcher is generally enabled to select a particular energy source amongst a plurality of energy sources, by taking into account time-varying pricing references for one or more of available energy sources during a certain period.

The present invention pertains to an input-power switcher for a telecom site. The switcher comprises a sourcing unit for configuring two or more alternative energy sources as available at the telecom site. The switcher comprises a pricing unit for storing time-varying price references from one or more different suppliers for at least one of the two or more alternative energy sources. The switcher comprises a processing unit for selecting one amongst the two or more alternative energy sources for powering the telecom site. The selection is made on the basis of the alternative energy sources available at the telecom site and the time-varying price references in the pricing unit. The processing unit is in communication with the sourcing unit and the pricing unit. The switcher comprises an actuator unit for switching to the selected alternative energy source for powering the telecom site. The actuator unit in communication with the processing unit.

This switcher may include a timer for configuring periods during which a switch is to be considered between two amongst the two or more alternative energy sources, the timer in communication with the processing unit Where this is the case, the processing unit may select, at the start of a particular period announced by the timer, the one amongst the two or more alternative energy sources for powering the telecom site during the particular period, the selection made on the basis of: the particular period, the alternative energy sources available at the telecom site and the time-varying price references in the pricing unit.

This switches may include a performance evaluator for determining, whether each of the two or more alternative energy sources are operative, the performance evaluator in communication with each of the two or more alternative energy sources. Where this is the case, the processing unit may select the one amongst the two or more alternative energy sources for powering the telecom site, the selection made on the basis of the alternative energy sources that are determined as operative by the performance evaluator and the time-varying price references in the pricing unit. In particular, the performance evaluator may be configured with a minimum threshold value for each of the two or more alternative energy sources in order to determine whether each of the two or more alternative energy sources is operative.

The present invention pertains to a method of using an input-power switcher for a telecom site. The method comprises the steps of configuring with a sourcing unit two or more alternative energy sources as available at the telecom site. There is the step of storing in a pricing unit time-varying price references from one or more different suppliers for at least one of the two or more alternative energy sources. There is the step of selecting with a processing unit one amongst the two or more alternative energy sources for powering the telecom site. The selection is made on the basis of the alternative energy sources available at the telecom site and the time-varying, price references in the pricing unit. The processing unit is in communication with the sourcing unit and the pricing unit. There is the step of switching with an actuator unit to the selected alternative energy source for powering the telecom site. The actuator unit is in communication with the processing unit.

This method may include the step of configuring with a timer periods during which a switch is to be considered between two amongst the two or more alternative energy sources, the timer in communication with the processing unit. Where this is the case, this method may further include the step of the processing unit selecting, at the start of a particular period announced by the timer, the one amongst the two or more alternative energy sources for powering the telecom site during the particular period, the selection made on the basis of the particular period, the alternative energy sources available at the telecom site and the time-varying price references in the pricing unit.

This method may include the step of determining with a performance evaluator whether each of the two or more alternative energy sources are operative, the performance evaluator in communication with each of the two or more alternative energy sources. Where this is the case, this method may further include the step of the processing unit selecting the one amongst the two or more alternative energy sources for powering the telecom site, the selection made on the basis of: the alternative energy sources that are determined as operative by the performance evaluator and the time-varying, price references in the pricing unit in particular, this method may further include the step of configuring the performance evaluator with a minimum threshold value for each of the two or more alternative energy sources in order to determine whether each of the two or more alternative energy sources is operative.

### BRIEF DESCRIPTION OF THE DRAWING

In the accompanying drawings, the preferred embodiment of the invention and preferred methods of practicing the invention are illustrated in which:

FIG. 1 is a graph showing time varying electricity price.

FIG. 2 shows a switcher with inputs the switcher receives.

FIG. 3 is a block diagram showing the methodology of the present invention.

FIG. 4 is a block diagram of a switcher of the present invention.

### DETAILED DESCRIPTION

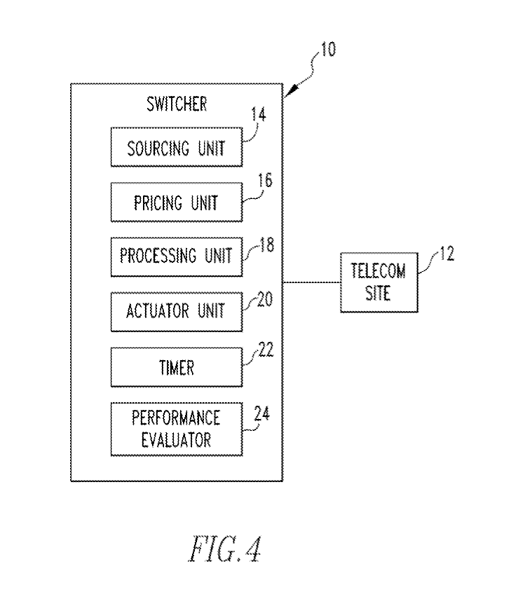

Referring now to the drawings wherein like reference numerals refer to similar or identical parts throughout the several views, and more specifically to FIG. 4 thereof, there is shown an input-power switcher 10 for a telecom site 12. The switcher 10 comprises a sourcing unit 14 for configuring two or more alternative energy sources as available at the telecom site 12. The sourcing unit 14 may be in communication with the two or more alternative energy sources in accordance with an embodiment of the invention, but it may also be configured without being in communication with the two or more alternative energy sources. The switcher 10 comprises a pricing unit 16 for storing time-varying price references from one or more different suppliers for at least one of the two or more alternative energy sources. The switcher 10 comprises a processing unit 18 for selecting one amongst the two or more alternative energy sources for powering the telecom site 12. The selection is made on the basis of the alternative energy sources and the time-varying price references in the pricing unit 16. The processing unit 18 is in communication with the sourcing, unit 14 and the pricing unit 16. The switcher 10 comprises an actuator unit 20 for switching to the selected alternative energy source for powering the telecom site 12. The actuator unit 20 in communication with the processing unit 18.

The processing unit may be, for instance, a computer or microprocessor. The pricing unit includes not-transitory memory or storage. In regard to the sourcing unit, there are ninny possible ‘alternative energy sources’, however, not all of them are available worldwide. For example, at a certain country (or land) one may always have solar energy but not wind energy; in another, one might have petrol or diesel generators along with AC grid but not wind, water or solar power. There may be, firstly, an action of selecting/configuring/defining those alternative energy sources which are available at a certain site and, secondly, at a certain period of time, there may be an action of determining whether or not all the available alternative energy sources are really operative (for example, during night the solar power is not operative, or the diesel reservoir is empty, or wind speed is too low).

The switcher 10 may include a timer 22 for configuring periods during which a switch is to be considered between two amongst the two or more alternative energy sources. The timer 22 may be in communication with the processing unit 18. The processing unit 18 may select, at the start of a particular period announced by the timer 22, the one amongst the two or more alternative energy sources for powering the telecom site 12 during the particular period. The selection may be made on the basis of: the particular period, the alternative energy sources and the time-varying price references in the pricing unit 16.

The switcher may include a performance evaluator 24 for determining whether each of the two or more alternative energy sources are operative. The performance evaluator 24 may be in communication with each of the two or more alternative energy sources. The processing unit 18 may select the one amongst the two or more alternative energy sources for powering the telecom site 12. The selection may be made on the basis of: the alternative energy sources that are determined as operative by the performance evaluator 24 and the time-varying price references in the pricing unit 16. To this end, the processing unit 18 may be also in communication with the performance evaluator 24. The performance evaluator 24 may be configured with a minimum threshold value for each of the two or more alternative energy sources in order to determine whether each of the two or more alternative energy sources is operative.

In particular, where the switcher includes the timer 22 and the performance evaluator 24, the selection may be made by the processing unit 18 on the basis of: the particular period, the alternative energy sources that are determined as operative by the performance evaluator 24 and the time-varying price references in the pricing unit 16.

The two or more alternative energy sources may be anyone of battery backup, diesel generator, petrol generator, gas plant, water power, wind power, solar power, or AC grid power. In particular, such gas plant, water power, wind power and solar power are arranged to produce electricity as the diesel and petrol generators do.

The present invention pertains to a method of using an input-power switcher 10 for a telecom site 12. The method comprises the steps of configuring with a sourcing unit 14 two or more alternative energy sources as available at the telecom site 12. The sourcing unit 14 may be in communication with the two or more alternative energy sources in accordance with an embodiment of the invention, but it may also be configured without being in communication with the two or more alternative energy sources. There is the step of storing in a pricing unit 16 time-varying price references from one or more different suppliers for at least one of the two or more alternative energy sources. There is the step of selecting with a processing unit 18 one amongst the two or more alternative energy sources for powering the telecom site 12. The selection is made on the basis of the alternative energy sources and the time-varying price references in the pricing unit 16. The processing unit 18 is in communication with the sourcing unit 14 and the pricing unit 16. There is the step of switching with an actuator unit 20 to the selected alternative energy source for powering the telecom site 12. The actuator unit 20 is in communication with the processing unit 18.

There may be the step of configuring with a timer 22 periods during which a switch is to be considered between two amongst the two or more alternative energy sources. The timer 22 may be in communication with the processing unit 18. There may be the step of the processing unit 18 selecting, at the start of a particular period announced by the timer 22, the one amongst the two or more alternative energy sources for powering the telecom site 12 during the particular period. The selection may be made on the basis of: the particular period, the alternative energy sources and the time-varying price references in the pricing unit 16.

There may be the step of determining with a performance evaluator 24 whether each of the two or more alternative energy sources is operative. The performance evaluator 24 may be in communication with each of the two or more alternative energy sources. There may be the step of the processing unit 18 selecting the one amongst the two or more alternative energy sources for powering the telecom site 12. The selection may be made on the basis of: the alternative energy sources that are determined as operative by the performance evaluator 24 and the time-varying price references in the pricing unit 16. To this end, the processing unit 18 may be also in communication with the performance evaluator 24. There may be the step of configuring the performance evaluator 24 with a minimum threshold value for each of the two or more alternative energy sources in order to determine whether each of the two or more alternative energy sources is operative.

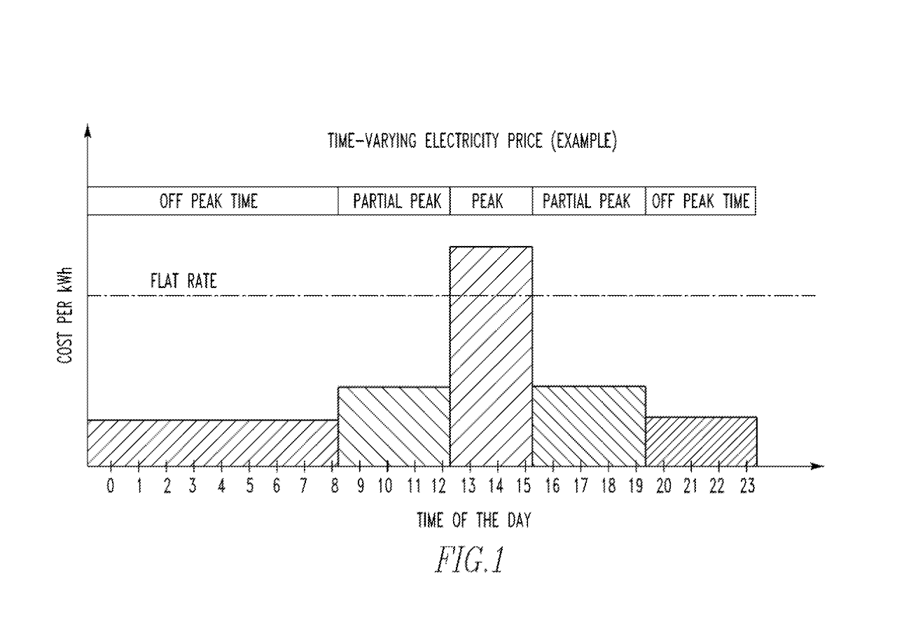

In the operation of the invention, the difference in electricity price between peak period (highest price) and off-peak period (lowest price) can easily be greater than 80%, when considering time-varying pricing for AC grid power. It can also happen that a flat rate pricing reference is used. Both flat rates and time-varying prices are public and stable during weeks or months, being updated periodically by electricity companies. See FIG. 1. Electricity main is not the unique power source for mobile telecom sites, but other alternative power sources may be considered whenever a site is engineered. As commented above, there is thus a need to provide a solution that dynamically and flexibly accommodates a choice amongst different energy sources to feed a telecom site 12 in order to allow mobile operators to reduce significantly the energy invoices to be paid. Mobile operators worldwide manage thousands of sites, and expend huge amounts of money to pay their energy bills to electricity supplier companies, being this fact responsible for an important part of their OPEX.

The present invention provides a solution for a programmable input-power switcher 10 for telecom sites according to time-varying electricity prices. This input-power switcher 10 enables to select a particular energy source amongst a plurality of energy sources, by taking into account time-varying energy pricing references for one or more of the site existing energy sources during a certain period, availability and proper operation of different input power options, and exact time of the day.

Nowadays, time-varying electricity prices are not taken into account to make decisions regarding, which is the most appropriate source of power for a site, but only other criteria based on grid availability or stability, installed battery backup capacity, etc. However, when analyzing the significant differences in cost of energy during, different periods of the day, it makes sense to introduce the time-varying price information into the selection methodology.

The input-power switcher 10 minimizes the grid power consumptions during, high price periods, prioritizing the use of cheaper alternative power sources all that periods long, in accordance with its current configuration. Avoiding, or at least reducing, AC grid power consumption during high price periods produces a very significant reduction in the energy bill to be paid to electricity suppliers, thus reducing OPEX and improving financial results of any telecom operator.

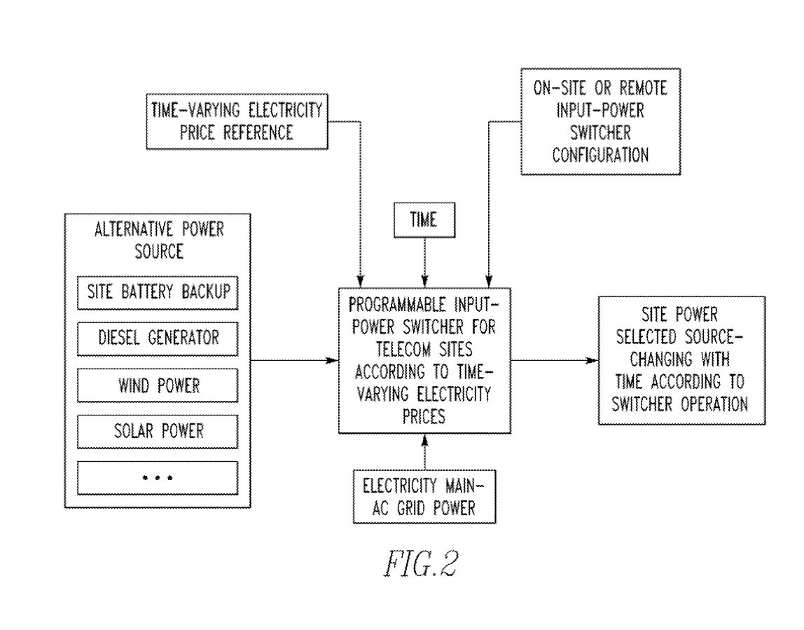

Referring to FIG. 2, the programmable input-power switcher 10 configuration may be performed in different ways, both on-site and remotely. In order to configure the switcher 10 remotely, different, non-exclusive alternatives can be used, as for example a dedicated wireless connection, or the adaptation of an already existing O&M connection to the RBS or other site elements. Also on-site configuration capability is required, especially during initial equipment installation, unavailability of remote connections or equipment malfunctioning situations.

Energy prices for the different sources, including time-varying electricity price references, may be collected externally to the input-power switcher 10. The price of energy is public and always available to energy suppliers' customers. Typically this information can be found in internet or in every invoice received b the customer. Electricity prices are updated periodically by electricity companies, remaining stable during weeks or months. This information may be taken as a reference for an optimum configuration of the programmable input-power switcher 10. Variations in energy prices may lead to a reconfiguration of the input-power switcher 10 operation mode. The need for an updated configuration may be decided outside the input-power switcher 10 by the site responsible persons, and communicated accordingly to the input-power switcher 10 using either the on-site or remote configuration mechanism implemented. Normally the remote configuration mechanism may be preferred, in order to avoid thousands of site visits every time that a modification in reference prices may lead to a switcher's reconfiguration.

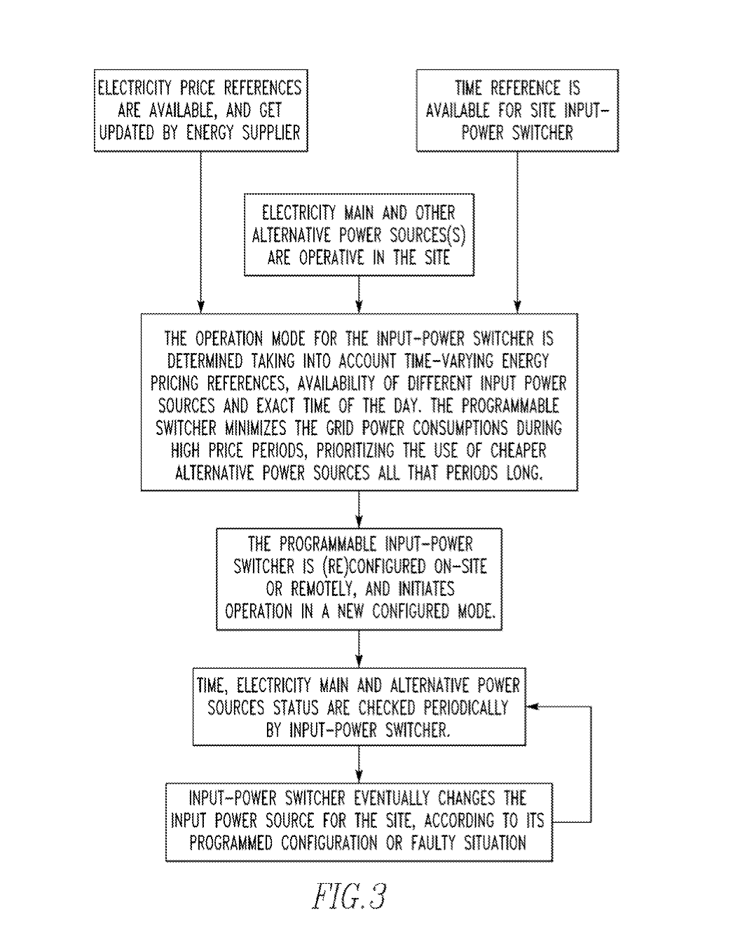

More specifically, this input-power switcher may comprise a number of functional units:
A sourcing unit 14 for configuring two or more alternative energy sources, as available at the telecom site 12: AC grid power, battery backup, diesel generator, wind power, solar power, etc.
A pricing unit 16 for storing time-varying price references from one or more different suppliers for at least one of the two or more alternative energy sources.
A timer 22 for configuring periods during which a switch is to be considered between two amongst the two or more alternative energy sources.
A performance evaluator 24 for determining whether each of the two or more alternative energy sources are operative (battery backups are correctly charged, diesel generator are above a certain minimum level, AC grid power is stable, etc.).
A processing unit 18 for selecting, at the start of a particular period announced by the timer 22 or as required by the fault management unit, one amongst the two or more alternative energy sources for powering the telecom site 12 during the particular period. The selection is made on the basis of: the particular period, the alternative energy sources that are determined as operative by the performance evaluator 24, the time-varying price references in the pricing unit 16, and the actual operation mode configuration for the input-power switcher 10.
An actuator unit 20 for switching to the selected alternative energy source for powering the telecom site 12 during the particular period,
A fault management unit, which is not illustrated in any drawing and may be included in the switcher 10 or be provided separately, to react in the event of any fault or critical condition (for example, if battery voltage becomes too low, diesel generator becomes faulty, mains failure, etc.). This unit informs the processing unit 18, generates specific alarms and transmits these alarms to O&M site responsible using the remote connection. The methodology for the invention is described in the block diagram of FIG. 3.

### ABBREVIATIONS

AC A/C, Alternating Current

OPEX Operational Expenditures

O&M Operation and Maintenance

RAN Radio Access Network

RBS Radio Base Station

Although the invention has been described in detail in the foregoing embodiments for the purpose of illustration, it is to be understood that such detail is solely for that purpose and that variations can be made therein by those skilled in the art without departing from the scope of the invention except as it may be described by the following claims.

1. An input-power switcher for a telecom site comprising:
a sourcing unit for Configuring two or more alternative energy sources as available at the telecom site;
a pricing unit for storing time-varying price references from one or more different suppliers for at least one of the two or more alternative energy sources;
a processing unit for selecting one amongst the two or more alternative energy sources for powering the telecom site, the selection made on the basis of the alternative energy sources available at the telecom site and the time-varying price references in the pricing, unit, the processing unit in communication with the sourcing unit and the pricing unit; and
an actuator writ for switching to the selected alternative energy source for powering the telecom site, the actuator unit in communication with the processing unit.

2. The switcher of claim 1 including a timer for configuring periods during which a switch is to be considered between two amongst the two or more alternative energy sources, the timer in communication with the processing unit.

3. The switcher of claim 2 wherein the processing unit selects, at the start of a particular period announced by the timer, the one amongst the two or more alternative energy sources for powering the telecom site during the particular period, the selection made on the basis of the particular period, the alternative energy sources and the time-varying price references in the pricing unit.

4. The switcher of claim 1 including a performance evaluator for determining whether each of the two or more alternative energy sources are operative, the performance evaluator in communication with each of the two or more alternative energy sources.

5. The switcher of claim 4 wherein the processing unit selects the one amongst the two or more alternative energy sources for powering the telecom site, the selection made on the basis of the alternative energy sources that are determined as operative by the performance evaluator and the time-varying price references in the pricing unit.

6. The switcher of claim 4 wherein the performance evaluator is configured with a minimum threshold value for each of the two or more alternative energy sources in order to determine whether each of the two or more alternative energy sources is operative,

7. The switcher of claim 1 wherein the two or more alternative energy sources are anyone of: battery backup, diesel generator, petrol generator, gas plant, water power, wind power, solar power, AC grid power.

8. A method of using an input-power switcher for a telecom site comprising the steps of
configuring with a sourcing unit two or lore alternative energy soirees as available at the telecom site;
storing in a pricing unit time-varying price references from one or more different suppliers for at least one of the two or more alternative energy sources;
selecting with a processing unit one amongst the two or more alternative energy sources for powering the telecom site, the selection made on the basis of the alternative energy sources available at the telecom site and the time-varying puce references in the pricing unit, the processing unit in communication with the sourcing unit and the pricing unit; and
switching with an actuator unit to the Selected alternative energy source for powering the telecom site, the actuator unit in communication with the processing unit.

9. The method of claim 8 including the step of configuring with a timer periods during which a switch is to be considered between two amongst the two or more alternative energy sources, the timer in communication with the processing unit.

10. The method of claim 9 including the step of the processing unit selecting, at the start of a particular period announced by the timer, the one amongst the two or more alternative energy sources for powering the telecom site during the particular period, the selection made on the basis of: the particular period, the alternative energy sources available at the telecom site and the time-varying price references in the pricing unit.

11. The method of claim 8 including the step of determining with a performance evaluator whether each of the two or more alternative energy sources are operative, the performance evaluator in communication with each of the two or more alternative energy sources.

12. The method of claim 11 including the step of the processing unit selecting the one amongst the two or more alternative energy sources for powering the telecom site, the selection made on the basis of the alternative energy sources that are determined as operative by the performance evaluator and the time-varying price references in the pricing unit.

13. The method of claim 11 including the step of configuring the performance evaluator with a minimum threshold value for each of the two or more alternative energy sources in order to determine whether each of the two or more alternative energy sources is operative.

14. The method of claim 8 wherein the two or more alternative energy sources are anyone of battery backup, diesel generator, petrol generator, gas plant, water power, wind power, solar power, AC grid power.

15. An input-power switcher for a telecom site comprising:
a sourcing unit for configuring two or more alternative energy sources of battery backup, diesel generator, petrol generator, gas plant, water power, wind power, solar power, AC grid power, as available at the telecom site;
a pricing, unit for storing time-varying price references from one or more different suppliers for at least one of the two or more alternative energy sources;
a timer for configuring periods during, which a switch is to be considered between. two amongst the two or more alternative energy sources;
a performance evaluator for determining whether each of the two or more alternative energy sources, which are available at the telecom site, are operative;
a processing unit for selecting, at the start of a particular period announced by the timer, one amongst the two or more alternative energy sources for powering the telecom site during the particular period, the selection made on the basis of: the particular period, the alternative energy sources that are determined as operative by the performance evaluator, and the time-varying price references in the pricing unit; and
an actuator unit for switching to the selected alternative energy source for powering the telecom site during the particular period.
